(19) United States
(12) Patent Application Publication
(10) Pub. No.: US 2025/0202876 A1
(43) Pub. Date: Jun. 19, 2025

(54) METHOD AND SYSTEM FOR CONNECTING A HOUSEHOLD APPLIANCE TO A CLOUD COMPUTING SYSTEM

(71) Applicant: ELECTROLUX APPLIANCES AKTIEBOLAG, Stockholm (SE)

(72) Inventor: Igor PERELYGIN, Stockholm (SE)

(73) Assignee: ELECTROLUX APPLIANCES AKTIEBOLAG, Stockholm (SE)

(21) Appl. No.: 18/843,365

(22) PCT Filed: Mar. 3, 2022
(86) PCT No.: PCT/EP2022/055339

§ 371 Date: Sep. 3, 2024

(51) Int. Cl. H04L 9/40

(52) U.S. Cl. CPC H04L 63/08

(57) ABSTRACT

A method for connecting an appliance to a cloud computing system by a portable communication device is disclosed herein. The method may include storing in said appliance and said cloud computing system a first code and a second code associated with said appliance, communicating said first code stored in said appliance to said cloud computing system via said portable communication device, comparing said first code of said appliance with said first code of said cloud computing system, communicating said second code of said cloud computing system to said appliance when said first code received from said portable communication device corresponds to said first code of said cloud computing system, verifying a first security condition when said second code received from said cloud computing system corresponds to said second code of said appliance, and authorizing or preventing a connection between said appliance and said cloud computing system based on the result.

The present invention relates to a method and a system for connecting a household appliance to a cloud computing system. More specifically, the present invention concerns with performing a cloud provisioning of a household appliance with a cloud computing system by means of a portable communication device.

### BACKGROUND ART

As is known, many of the latest generation domestic appliances are cloud household apparatus, i.e. household apparatus which are configured to communicate with a cloud computing system in order to get to cloud services usually provided by the household apparatus's manufacturer.

The exchange of data between household appliances and cloud systems is conveniently carried out for multiple services and functions, which are made available by household apparatus's manufacturers.

For example, cloud systems may be configured to receive in input data concerning with operations performed by household appliances during their operating cycles and may provide to household appliances data containing software/programs and/or setting information. Moreover, cloud systems are usually managed by appliance's manufacturers to exchange data/commands with mobile applications (APP) installed in portable communication devices in order to conveniently allow users to get to several cloud services, such as for example performing remotely command functions by the portable communication device or receiving in real time data from household appliances, etc.

While, on the one hand, the connection between cloud systems and household appliances makes it possible to obtain several advantages for users and manufacturers, on the other hand, it exposes the cloud systems and the household appliances to IT security problem (Internet Technology security).

Tests made by the Applicant has proved that cloud systems may be vulnerable during the so called “provisioning steps”, which is when the household appliances perform the operations to be authenticated by the cloud system in order to be authorized to be connected with the latter to start to get cloud services.

Some systems, such as the system disclosed in CN110572305 A, deal with the problem of IT security during the provisioning step, but results are not completely satisfactory, because, on the one hand, such systems are complex to be performed and, on the other hand, they remain exposed to risks that the provisioning data exchanged between the household appliance and the mobile device during the provisioning steps may be fraudulently intercepted by unauthorized users/intruders.

Therefore, the object of the invention is to provide a method and system for connecting household appliances to cloud systems, which have low complexity and increase the IT security, in particular during the provisioning operations.

### DISCLOSURE OF INVENTION

In compliance with the above aims, according to the present invention, it is provided a method for connecting a household appliance to a cloud computing system by means of a portable communication device; the method comprises the steps of: storing security data in said household appliance wherein said security data comprise a first code and a second code which are univocally associated to said household appliance, storing said security data in said cloud computing system, communicating said first code stored by the household appliance to the cloud computing system via said portable communication device, comparing by said cloud computing system said first code received from said household appliance with said first code stored in said cloud computing system, communicating by said cloud computing system the second code associated with said first code of said cloud computing system to said household appliance via said portable communication device when said first code received from said portable communication device corresponds to said first code stored in said cloud computing system, verifying by said household appliance a first security condition when said second code received from said cloud computing system corresponds to said second code associated with said first code stored in said household appliance, and authorizing or preventing the connection between said household appliance and said cloud computing system based on the result of the verification of said first security condition.

Preferably, the method further comprises: authorizing or preventing said cloud computing system to perform a provisioning process which allows said household appliance to access the cloud services of said cloud computing system, based on the result of the verification of said first security condition.

Preferably, the method further comprises: authorizing or preventing a pairing process between said household appliance and said portable communication device based on the result of the verification of said first security condition.

Preferably, the method further comprises: when the pairing process between said household appliance and said portable communication device is authorized, communicating by said household appliance to said cloud computing system via said portable communication device a notification indicating that said first security condition is verified; when the cloud computing system receives said notification, authorizing said cloud computing system to perform a provisioning process which allows said household appliance to access the cloud services of said cloud computing system.

Preferably, said first code stored by the household appliance is communicated to the cloud computing system via said portable communication device without performing a pairing process between the household appliance and the portable communication device.

Preferably, the method comprises the step of authorizing the connection between said household appliance and said cloud computing system, when said first security condition is verified, and preventing the connection between said household appliance and said cloud computing system, when the said first security condition is not verified.

Preferably, said security data further comprise a third code and a fourth code, which is associated to said third code. Moreover, when the first security condition is verified and before of authorizing the connection between said household appliance and said cloud computing system, the method further comprises: communicating by said cloud computing system said third code of security data stored in said cloud computing system to the household appliance, comparing by said household appliance said third code received from said cloud computing system with said third code of security data stored in said household appliance, communicating said fourth code associated with the third code stored in said household appliance to said cloud computing system, when said third code received from cloud computing system matches said third code stored in said household appliance, verifying a second security condition when said fourth code received from said household appliance corresponds to said fourth code stored in said cloud computing system, and authorizing or preventing the connection of the household appliance to said cloud computing system based on the result of the verification of said second security condition.

Preferably, the method further comprise the step of authorizing the connection between said household appliance and said cloud computing system, when said first and second security conditions are verified, and preventing the connection between said household appliance and said cloud computing system when the first and/or second security conditions are not verified.

Preferably, the first code comprises a first part associated with a code which univocally identifies said household appliance and a second part associated with a hash code; said second code comprises a provisioning code.

Preferably, said portable communication device communicates with said household appliance by a wireless short-range communication system.

Preferably, said household appliance comprises a laundry treating machine, or a food preservation appliance, like a refrigerator or a freezer, or a dishwasher, or a cooking appliance, like an oven.

The present invention further relates to a system for connecting a household appliance to a cloud computing system by using a portable communication device, wherein: said household appliance is configured to store security data comprising a first code and a second code, which are univocally associated to said household appliance; said cloud computing system is configured to store said security data; said household appliance is configured to communicate said first code to the cloud computing system via said portable communication device; said cloud computing system is configured to compare said first code received from said household appliance with said first code stored in said cloud computing system and to communicate the second code associated with said first code to said household appliance via said portable communication device, when said first code received from said portable communication device corresponds to said first code stored in said cloud computing system; said household appliance is configured to verify a first security condition, when said second code received from said cloud computing system corresponds to said second code associated with said first code stored in said household appliance; said cloud computing system is configured to authorize or prevent the connection with household appliance based on the result of the verification of said first security condition.

Preferably, said security data further comprise a third code and a fourth code associated to said third code. Still preferably, said cloud computing system is configured to communicate said third code of security data stored in said cloud computing system to the household appliance, when said first security condition is verified and before of authorizing the connection between said household appliance and said cloud computing system; said household appliance is configured to compare said third code received from said cloud computing system with said third code of security data stored in said household appliance, and to communicate said fourth code associated with the third code stored in said household appliance to said cloud computing system, when said third code received from cloud computing system matches said third code stored in said household appliance; said cloud computing system is configured to verify a second security condition when said fourth code received from said household appliance corresponds to said fourth code stored in said cloud computing system, and to authorize or prevent the connection of the household appliance to said cloud computing system based on the result of the verification of said second security condition.

Further characteristics and advantages of the present invention will be highlighted in greater detail in the following detailed description of some of its preferred embodiments, provided with reference to the enclosed drawings.

In the Figures, corresponding characteristics and/or components are identified by the same reference numbers.

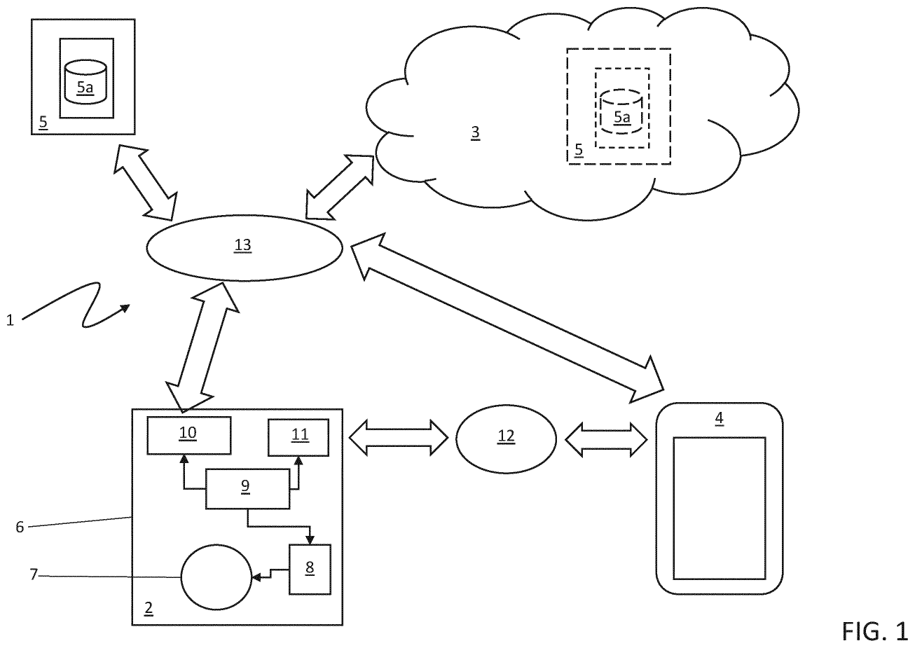

FIG. 1 schematically illustrates a system for connecting a household appliance to a cloud computing system made according to an exemplary embodiment of the present invention,

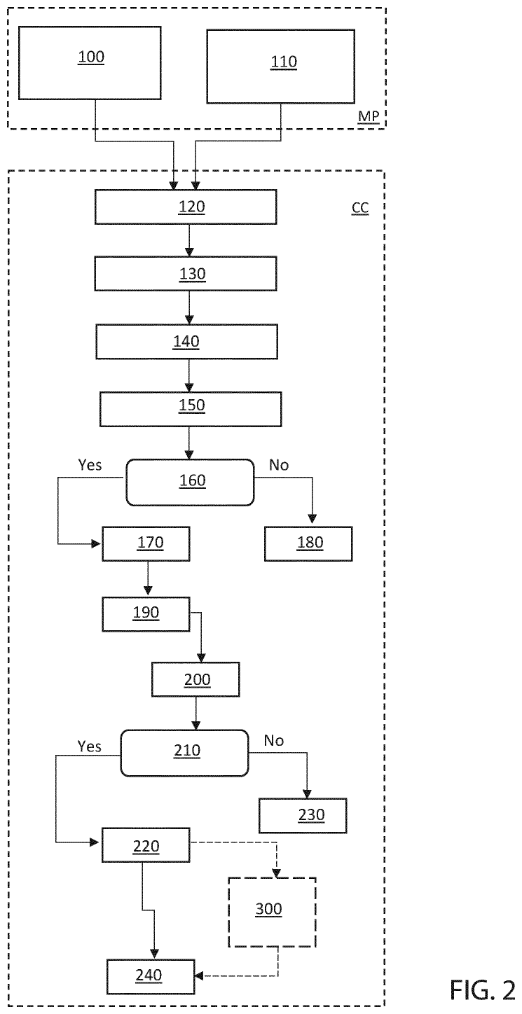

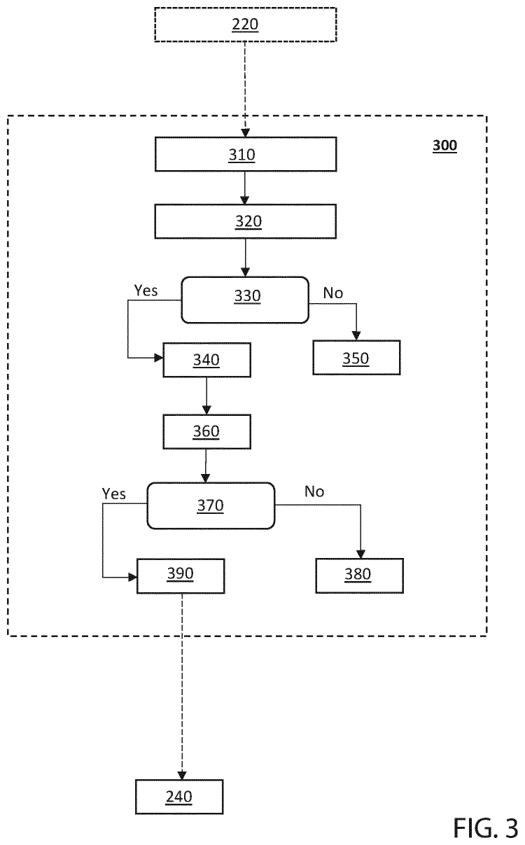

FIGS. 2 and 3 are flow charts comprising operations performed by the system for connecting a household appliance to a cloud computing system made according to the present invention.

### DETAILED DESCRIPTION OF THE INVENTION

Configurations shown in embodiments enumerated in the present specification and Figures are just exemplary embodiments of the present disclosure.

With reference to FIG. 1, reference number 1 indicates as a whole a system for connecting a household appliance 2 to a cloud computing system 3 by means of a portable communication device 4.

According to present invention, the household appliance is to be understood as a machine that is used for domestic activities. This can especially be a major domestic appliance such as a machine for the care of laundry items, a cooker, a refrigerator, a fridge/freezer combination, an air conditioning device, a dishwasher or an oven.

As illustrated in the exemplary embodiment of FIG. 1 and with reference to the following description, the domestic appliance may be a laundry-treating machine. The laundry-treating machine may be, for example, a laundry washing machine, a washing-drying machine, a laundry dryer machine, or the like.

FIG. 1 schematically illustrates an example of a household appliance 2 comprising: an outer casing 6; an inner cavity 7 arranged inside the casing 6 and directly facing a laundry loading/unloading opening (not illustrated) formed in casing 6; and a door (not illustrated) connected to the casing 6 and movable, e.g. rotatable, between an open position and a closed position. According to the exemplary embodiment illustrated in FIG. 1, the inner cavity 7 of the laundry washing machine 2 may correspond to a revolving laundry drum. Typically, the laundry drum is supported in the casing 6 in order to rotate around a rotation axis. The laundry drum may be driven by an electric motor 8, which is controlled by an electronic control system 9 comprising a control unit of the household appliance 2. The control unit of the electronic control system 9 may be configured to store data/programs or databases and control the operations of the household appliance 2, typically based on programs selected by the user.

According to the present invention, the portable communication device 4 is to be understood as a mobile apparatus, which is embodied for wireless communication in accordance with a predetermined standard communication and on which new mobile applications APP (computer programs) can be installed and then executed.

For example, the portable communication device 4 may be a mobile telephone, a smartphone, a tablet, a laptop or any similar mobile apparatus. It is understood that the portable communication device 4, as the most known mobile devices, comprises a display and memory modules, which store mobile applications (software applications). The portable communication device 4 may comprise a control module (not illustrated) configured to control the electronic modules/circuits/components of the portable communication device 4 at least according to the steps of the method hereinafter disclosed in detail.

Moreover, it is understood that the portable communication device 4 is configured to perform a short-range communication with the household appliance 2 through a communication system 12. In the following description, with “short-range communication” it is understood a standard for wireless communication, having a range of a few meters. According to a preferred embodiment of the present invention, the short-range communication system 12 may implement a Bluetooth communication or the like.

Moreover, it is understood that the portable communication device 4 is configured to perform a long-range communication with the household appliance 2 through a communication system 13. The communication system 13 may comprise any kind of known wireless systems, networks or platforms, commonly used to connect local devices or apparatuses to a cloud computing system. For example, the communication system 13 may comprise LAN networks, WAN networks or the like.

With reference to FIG. 1, the household appliance 2 further comprises a first communication device 10, which is configured to exchange data with the cloud computing system 3 through the communication system 13. The household appliance 2 further comprises a second communication device 11, which is configured to exchange data with the portable communication device 4 by the communication system 12.

According to the preferred embodiment illustrated in FIG. 1, the system 1 may comprise a remote management system 5. As illustrated in an exemplary embodiment of FIG. 1, the remote management system 5 may be part of, or included in, the cloud computing system 3. It is however understood that the present invention is not limited to a system 1 wherein the remote management system 5 is part of, or included in, the cloud computing system 3, but different embodiments may be envisaged wherein, for example, the remote management system 5 may communicate with the cloud computing system 3 by the communication system 13.

According to the exemplary embodiment illustrated in FIG. 1, the remote management system 5 may comprises one or more servers 5a, preferably managed by, or on the behalf of, the household appliance's manufacturer. The servers 5a may further comprise one or more databases configured to memorize data.

According to a preferred embodiment of the present invention illustrated in FIG. 2, the method for connecting the household appliance 1 to the cloud computing system 3 will be hereinafter disclosed.

The method comprises the step of storing into the household appliance 2 security data univocally associated to the household appliance 2 (block 100).

The security data comprises at least a first code, hereinafter indicated with unique code UC, which univocally identifies the household appliance 2. Conveniently. the unique code UC may comprise, for example, an identification code IC of the household appliance 2 and preferably a unique hash code UHC. According to a preferred embodiment, the identification code IC may comprise, for example, a serial number of the household appliance 2 and a MAC-address (Media Access Control address). The hash code UHC of the household appliance 2 may be provided by hash code algorithms, functions or tables or the like.

The security data further comprise a second code, hereinafter indicated with provisioning code RP, which is univocally associated with the unique code UC.

The provisioning code RP may be loaded/stored into the household appliance at the same time as together with the unique code UC, or at two different times. Preferably, the provisioning code RP may be a password, an alphanumeric code or the like. Preferably, the provisioning code RP of the household appliance 2 may be provided by automated generator password algorithms, functions or the like.

In other words, the method preferably comprises the step of storing into the household appliance 2 a table or array of security data including the unique code UC and the provisioning code RP univocally associated to the unique code UC of the household appliance 2.

The method further comprises the step of storing the security data of the household appliance 2 into the remote management system 5. Preferably, the method may further comprise the step of storing into the remote management system 5 a plurality of security data related to a plurality of household appliances (block 110). The security data may be stored, for example, in the databases of the server 5a. The server 5a may comprise a database of the manufacturer, which stores security data of a plurality household appliances.

Both steps disclosed above (block 100 and 110) may be performed by the enterpriser (manufacturer), for example during the manufacturing process (dotted-line block MP in FIG. 2) of household appliances intended to have the connection with the cloud computing system 3. It may be envisaged an electronic system (not illustrated) which is configured to generate security data. Preferably electronic system (not illustrated) may: generate the unique codes UC, set the provisioning codes RP univocally associated to the respective unique codes UC and store the security data comprising the generated unique codes UC and the provisioning codes RP in the database of the server 5a. Said electronic system may be further configured to store the security data comprising the generated unique codes UC and the associated provisioning codes RP into respective household appliances 2.

After purchasing the household appliance 2 and installing it at home, the connection and provisioning processes can be carried out (dotted line block CC in FIG. 2).

For this purpose, the user may be allowed to install a corresponding household appliance management application HA-APP (computer program) in his/her portable communication device 4. It is understood that the household appliance management application HA-APP, when implemented by the portable communication device 4, causes the latter to perform the connection between the portable communication device 4 and the cloud computing system 3. It is also understood that the household appliance application HA-APP may be configured to automatically perform a cloud provisioning program wherein the cloud computing system 3 authenticates and registers the portable communication device 4.

The user may power-on the household appliance 2 and select a command, for example, by the control panel of the household appliance 2, in order to start the implementation of a cloud-connection program stored in the electronic control system 9 (block 120). The cloud-connection program, when implemented by the electronic control system 9, may cause the latter to perform, by the communication device 11, a short-range communication comprising the unique code UC of the security data stored in the household appliance 2.

In this phase, the communication device 11 communicates a short-range connection request comprising data codifying the unique code UC. More specifically, the communication device 11 of the household appliance 2 preferably broadcasts a short-range connection request comprising data codifying the unique code UC via the communication system 12.

The control panel of the household appliance 2 may be further configured to request the user to start/activate the application HC-APP installed in his portable communication device 4. In this step, the portable communication device 4 should be sufficiently close to the household appliance 2 so as to allow to perform the short-range communication with the communication module 11 of the household appliance 2 by means of the communication system 12.

In this step, the application HC-APP of the portable communication device 4, when activated, controls the portable communication device 4 to cause the portable communication device 4 to operate automatically in a scanning mode in order to look for other devices, which are communicating in the short range. The scanning mode may start for example when the operator selects/commands by the application HC-APP a request of connection of the household appliance with the cloud computing system 3.

If the short range communication between the household appliance 2 and the portable communication device 4 is a Bluetooth connection, the portable communication device 4 looks for other Bluetooth devices and receives from the household appliance 2 a Bluetooth connection request codifying the unique code UC.

In this way, the application HC-APP of the portable communication device 4 can receive the short-range connection request containing the unique code UC (block 130) communicated by the household appliance 2 which is not yet paired. It is understood that, during this step, the portable communication device 4 does not perform the “pairing process” (pairing algorithms) with the household appliance 2. During this step, the portable communication device 4 operates in order to look for the devices which are communicating in the short range, receives the connection request from the household appliance 2 and elaborates such connection request only to determine the unique code UC, without however performing the pairing process with the household appliance 2. In other words, the portable communication device 4 is configured in order to perform only the reception of the short-range connection request containing the unique code UC from the communication system 12 without registering or pairing the household appliance 2. When the portable communication device 4 operates in the scanning mode, it selectively receives the short-range connection request containing the unique code UC from the communication system 12 and determines the unique code UC, i.e. the hash code UHC and the identification code IC as part of communication.

After receiving the unique code UC, the application HC-APP of the portable communication device 4 commands the communication of the unique code UC from the portable communication device 4 to the cloud computing system 3 (block 140).

The cloud computing system 3 receives the unique code UC from the portable communication device 4 and communicates the unique code UC to the remote management system 5 (block 150).

The remote management system 5 receives the unique code UC from the cloud computing system 3 and determines in its database the security data associated with the received unique code UC. In this step, the remote management system 5 may search in the database of the server 5a whether there is a unique code UC stored which corresponds to the unique code UC received from the household appliance 2 (block 160).

If the remote management system 5 finds in its database a unique code UC which corresponds to the unique code UC of the household appliance 2 (output Yes from block 160), the remote management system 5 determines in the database the provisioning code RP associated to the unique code UC. In this case the remote management system 5 communicates the provisioning code RP to the cloud computing system 3 (block 170).

Vice-versa, if the remote management system 5 does not find in its database a unique code UC which corresponds to the unique code UC of the household appliance 2 (output No from block 160), the remote management system 5 does not communicate any provisioning code RP to the cloud computing system 3 (block 180). In this case, the remote management system 5 and/or the cloud computing system 3 may recognize a fraudulent IT action and preferably generate an IT alert communication.

After having received the provisioning code RP, the cloud computing system 3 communicates the provisioning code RP to the portable communication device 4 (block 190).

After having received the provisioning code RP from the cloud computing system 3, the portable communication device 4 may utilize the provisioning code RP to establish a secure connection with the household appliance 2, in order to start exchanging data with the latter by means of the communication system 12. In other words, after having received the provisioning code RP from the cloud computing system 3, the portable communication device 4 may utilize the provisioning code RP to perform the pairing process and registration with the household appliance 2.

In this step, during the pairing process, the portable communication device 4 communicates the provisioning code RP to the household appliance 2 by means of the communication system 12 (block 200).

After receiving the provisioning code RP from the portable communication device 4, the electronic control unit 9 of the household appliance 2 compares the provision code RP with the provisioning code RP associated with the unique code UC of the security data stored into the same household appliance 2 (block 210).

If the received provisioning code RP matches the provisioning code RP stored into the household appliance 2 (output Yes from block 210), the electronic control system 9 of the household appliance 2 determines a first security condition. In other words, the electronic control system 9 of the household appliance 2 determines the first security condition when the provisioning code RP received from cloud computing system 3 corresponds to the provisioning code RP associated with the unique code UC stored in the household appliance 2.

When the first security condition is determined, the electronic control system 9 performs a secure connection with the portable communication device 4 (block 220). Therefore, if the received provisioning code RP corresponds to the provisioning code RP associated with the unique code UC of the security data stored into the household appliance 2, the portable communication device 4 may perform the pairing and registration processes with the household appliance 2.

Vice-versa, if the received provisioning code RP does not correspond to the provisioning code RP stored into the household appliance 2 (output No from block 210), the electronic control system 9 does not determine the first security condition and prevents the connection the cloud computing system 3 is prevented. In this case, the portable communication device 4 does not perform the pairing and registration processes with the household appliance 2 (block 230). Moreover, in this case, the electronic control system 9 recognizes a fraudulent IT action and preferably generates an IT alert communication.

The technical effect of the further comparison step (block 210) between the provisioning code RP of household appliance 2 and the provisioning code RP of the cloud computing system 3 is to increase the IT security of the connection/provisioning between the household appliance 2 and the cloud computing system 3, without burdening the user experience. According to the disclosed method, in fact, the identity of the household appliance 2 is verified at least twice, both by the remote management system 5 and locally by the household appliance 2 itself before it can be provisioned in the cloud computing system 3.

Thereafter, if the received provisioning code RP of the cloud computing system 3 corresponds to the provisioning code RP stored into the household appliance 2, the same household appliance 2 may be provisioned into the cloud computing system 3 (block 240). More specifically, the portable communication device 4 may be configured to allow the household appliance 2 to be provisioned into the cloud computing system 3 once the identity of the household appliance has been verified.

After this step (block 240), the electronic control system 9 of the household appliance 2 may start to communicate data with the cloud computing system 3, and vice-versa. More specifically, in this step (block 240) the electronic control system 9 of the household appliance 2 performs the provisioning and registration process with the cloud computing system 3. It is understood that during the provisioning process. the provisioning code RP and/or the unique code UC may be processed by the cloud computing system 3 in order to register the household appliance 2 for providing to the latter the services available in the cloud computing system 3.

In addition to the above disclosed steps (block 100-230), the system 1 may conveniently perform an additional verification of a second security condition (block 300 in FIG. 2 illustrated with dotted lines), which will be hereinafter disclosed in detail and illustrated in the flow chart of FIG. 3 (block 300 containing blocks 310-390) and authorizes or prevents the provisioning of the household appliance 2 to the cloud computing system 3 (block 240) based on the result of a second security condition.

With reference to FIGS. 2 and 3, after performing the operations of the block 220, i.e. the verification of the first security condition, the system 1 may verify the second security condition. In this case, the security data stored in the household appliance 2 and in the database of the remote management system 5, further comprises for each household appliance 2, in addition to the unique code UC and the provisioning code RP, an additional unique code AUC (third code) and an additional provisioning code ARP (fourth code) associated with the additional unique code AUC

It is understood that the additional unique code AUC may have a structure of data similar to the structure of the unique code UC, i.e. comprising an additional identification code of the household appliance 2 and an additional hash code UHC provided by hash code algorithms, functions or tables or the like.

With reference to the flow chart illustrated in FIGS. 2 and 3, when the first security condition is verified and before the system 1 authorizes the connection between the household appliance 2 and the cloud computing system 3 (block 240), the household appliance 2 communicates to a cloud computing system 3 by the portable communication device 4 a notification indicating that the first condition has verified (block 310).

When the cloud computing system 3 receives the notification from the household appliance 2, it determines the additional unique code AUC associated with the household appliance 2, based on the security data stored in the database of the server 5a, and communicates the determined additional unique code AUC to same household appliance 2 by the portable communication device 4 (block 320).

The household appliance 2 receives the additional unique code AUC from household appliance 2 and determines if the received additional unique code AUC matches the additional unique code AUC stored in its database (block 330).

If the additional unique code AUC of household appliance 2 corresponds to the additional unique code AUC of the cloud computing system 3 (output Yes from block 330), the household appliance 2 determines in its database the additional provisioning code ARP associated to the additional unique code AUC. In this case, the household appliance 2 communicates the additional provisioning code ARP to the cloud computing system 3 (block 340) by means of the portable communication device 3.

Vice-versa, if the additional unique code AUC of household appliance 2 does not correspond to the additional unique code AUC of the cloud computing system 3, (output No from block 330), the household appliance 2 determines a fraudulent IT action. In this case, the household appliance 2 may interrupt the short range connection with the portable communication device 4, generates an IT alert communication and displays a warning message by the control panel of the household appliance 2 (block 350).

The cloud computing system 3 then receives the additional provisioning code ARP from the household appliance 2 via the portable communication device 4 (block 360).

After receiving the additional provisioning code ARP from the household appliance 2, the cloud computing system 3 compares the received additional provision code ARP with the additional provisioning code ARP associated with the additional unique code UC of the security data stored into the database of the server 5a (block 370).

If the additional provisioning code ARP of the household appliance 2 does not correspond to the additional provisioning code ARP of the cloud computing system 3 (output No from block 370), the cloud computing system 3 determines a fraudulent IT action (block 380). In this case, the cloud computing system 3 prevents the connection and provisioning operations with the household appliance 2. The cloud computing system 3 may further interrupt the connection with the portable communication device 4, and generates an IT alert communication.

If the additional provisioning code ARP of the household appliance 2 corresponds to the additional provisioning code ARP of the cloud computing system 3 (output Yes from block 370), the cloud computing system 3 determines the second security condition (block 390) and authorizes the connection with the household appliance 2. In this case, the cloud computing system 3 determines the second security condition when the additional provisioning code ARP received from the household appliance 2 matches with the additional provisioning code ARP associated with the additional unique code AUC stored in the cloud computing system 3. i.e. in the database of the remote management system 5.

After having determined the second security condition, the cloud computing system 3 performs the provisioning with household appliance 2 so that the household appliance 2 may start to communicate data with the cloud computing system 3 (block 240).

The system described above is advantageous as it increases the IT security of the connection between the household appliance and the cloud computing system. Indeed, the generation of the unique code and provisioning code and the use of such codes significantly reduce the risk of fraudulent attacks on the cloud system.

Furthermore, the system is completely automatic and does not require user actions. Moreover, the system is simple and inexpensive to be implemented as it does not require the use of additional electronic devices.

Clearly, changes and variations may be made to the present method and system without, however, departing from the scope of the present invention.

1. A method for connecting a household appliance to a cloud computing system by means of a portable communication device, the method comprising:
storing security data in said household appliance, wherein said security data comprise a first code and a second code which are univocally associated to said household appliance,
storing said security data in said cloud computing system,
communicating said first code stored in the household appliance to the cloud computing system via said portable communication device,
comparing, by said cloud computing system, said first code received from said household appliance with said first code stored in said cloud computing system,
communicating, by said cloud computing system, the second code associated with said first code of said cloud computing system to said household appliance via said portable communication device when said first code received from said portable communication device corresponds to said first code stored in said cloud computing system,
verifying, by said household appliance, a first security condition when said second code received from said cloud computing system corresponds to said second code associated with said first code stored in said household appliance,
authorizing or preventing the connection between said household appliance and said cloud computing system based on a result of the verification of said first security condition.

2. The method according to claim 1, further comprising the step of authorizing or preventing said cloud computing system to perform a provisioning process which allows said household appliance to access cloud services of said cloud computing system, based on the result of the verification of said first security condition.

3. The method according to claim 1, further comprising authorizing or preventing a pairing process between said household appliance and said portable communication device based on the result of the verification of said first security condition.

4. The method according to claim 3, further comprising:
when the pairing process between said household appliance and said portable communication device is authorized, communicating by said household appliance to said cloud computing system via said portable communication device a notification indicating that said first security condition is verified; and
when said cloud computing system receives said notification, authorizing said cloud computing system to perform a provisioning process which allows said household appliance to access cloud services of said cloud computing system.

5. The method according to claim 1, wherein said first code stored in the household appliance is communicated to the cloud computing system via said portable communication device without performing a pairing process between the household appliance and the portable communication device.

6. The method according to claim 1, further comprising the step of authorizing the connection between said household appliance and said cloud computing system when said first security condition is verified, and preventing the connection between said household appliance and said cloud computing system when said first security condition is not verified.

7. The method according to claim 1, wherein said security data further comprise a third code and a fourth code associated to said third code, and wherein the method further comprises, when the first security condition is verified and before authorizing the connection between said household appliance and said cloud computing system:
communicating, by said cloud computing system, said third code of security data stored in said cloud computing system to the household appliance,
comparing, by said household appliance, said third code received from said cloud computing system with said third code of security data stored in said household appliance,
communicating said fourth code associated with the third code stored in said household appliance to said cloud computing system, when said third code received from said cloud computing system matches with said third code stored in said household appliance,
verifying a second security condition when said fourth code received from said household appliance corresponds to said fourth code stored in said cloud computing system, and
authorizing or preventing the connection of the household appliance to said cloud computing system based on the result of the verification of said second security condition.

8. The method according to claim 7, comprising the step of authorizing the connection between said household appliance and said cloud computing system when said first and second security conditions are verified and preventing the connection between said household appliance and said cloud computing system when at least one of the first and second security condition is not verified.

9. The method according to claim 1, wherein said first code comprises a first part associated with a code which univocally identifies said household appliance and a second part associated with a hash code, and wherein said second code comprises a provisioning code.

10. The method according to claim 1, wherein said portable communication device communicates with said household appliance by a wireless short-range communication system.

11. The method according to claim 1, wherein said household appliance comprises a laundry-treating machine or a food preservation appliance or a dishwasher or a cooking appliance.

12. A system for connecting a household appliance to a cloud computing system by using a portable communication device, wherein the system comprises said household appliance and said cloud computing system, and wherein:
said household appliance is configured to store security data, wherein said security data comprise a first code and a second code which are univocally associated to said household appliance,
said cloud computing system is configured to store said security data,
said household appliance is configured to communicate said first code the cloud computing system via said portable communication device,
said cloud computing system is configured to compare said first code received from said household appliance with said first code stored in said cloud computing system, and to communicate the second code associated with said first code to said household appliance via said portable communication device when said first code received from said portable communication device corresponds to said first code stored in said cloud computing system,
said household appliance is configured to verify a first security condition when said second code received from said cloud computing system corresponds to said second code associated with said first code stored in said household appliance, and
said cloud computing system is configured to authorize or prevent the connection with household appliance based on a result of the verification of said first security condition.

13. The system according to claim 12 wherein:
said security data further comprise a third code and a fourth code which are associated with said household appliance,
said cloud computing system is configured to communicate said third code of security data stored in said cloud computing system to the household appliance when said first security condition is verified and before authorizing the connection between said household appliance and said cloud computing system,
said household appliance is configured to compare said third code received from said cloud computing system with said third code of security data stored in said household appliance and to communicate said fourth code associated with the third code stored in said household appliance to said cloud computing system when said third code received from said cloud computing system matches with said third code stored in said household appliance,
said cloud computing system is configured to verify a second security condition when said fourth code received from said household appliance corresponds to said fourth code stored in said cloud computing system, and to authorize or prevent the connection of the household appliance to said cloud computing system based on the result of the verification of said second security condition.

14. (canceled)

15. (canceled)

16. A method, comprising:
storing, with a household appliance, security data in the household appliance, wherein the security data comprises a first code and a second code which are univocally associated to the household appliance;
communicating, with the household appliance, the first code stored in the household appliance to a cloud computing system via a portable communication device;
receiving, from the cloud computing system, a second code stored in the cloud computing system via the portable communication device; and
verifying, with the household appliance, a first security condition when the second code received from the cloud computing system corresponds to the second code stored in the household appliance.

17. A method, comprising:
storing, with a cloud computing system, security data in the cloud computing system, wherein the security data comprises a first code and a second code which are univocally associated to a household appliance, the first and second code being also stored in the household appliance;
receiving, from the household appliance via a portable communication device, the first code stored in the household appliance;
comparing, by the cloud computing system, the first code received from the household appliance with the first code stored in the cloud computing system;
communicating, by the cloud computing system, the second code associated with the first code of the cloud computing system to the household appliance via the portable communication device when the first code received from the portable communication device corresponds to the first code stored in the cloud computing system; and
authorizing or preventing a connection between the household appliance and the cloud computing system based on a result of a verification of a first security condition by the household appliance, wherein the first security condition comprises when the second code received from the cloud computing system corresponds to the second code associated with the first code stored in the household appliance.
